(19) United States
(12) Patent Application Publication
(10) Pub. No.: US 2024/0210090 A1
(43) Pub. Date: Jun. 27, 2024

(54) Refrigeration Apparatus and Moisture-Absorbing Sheet

(71) Applicant: Vestel Elektronik Sanayi ve Ticaret A.S., Manisa (TR)

(72) Inventor: Erkan TUNAY, Manisa (TR)

(21) Appl. No.: 17/913,772

(22) PCT Filed: Mar. 25, 2020
(86) PCT No.: PCT/EP2020/058367

§ 371 Date: Sep. 22, 2022

(51) Int. Cl. F25D 17/04; F25D 21/04

(52) U.S. Cl. CPC F25D 17/042; F25D 21/04; F25D 2317/0411

(57) ABSTRACT

A refrigeration apparatus has a cool chamber for receiving items to be cooled. The refrigeration apparatus has a guide arrangement for guiding movement of a moisture-absorbing sheet into and out of the cool chamber so that the moisture-absorbing sheet can absorb moisture in the cool chamber. In an example, the moisture-absorbing sheet has one or more permanent magnets for removably attaching the moisture-absorbing sheet to a wall of the cool chamber. In another embodiment, the moisture-absorbing sheet has a water-absorbing layer for absorbing moisture from the cool chamber and a water-storage layer located inwardly of the water-absorbing layer for storing water.

### TECHNICAL FIELD

The present disclosure relates to a refrigeration apparatus and a moisture-absorbing sheet for use in a refrigeration apparatus.

### BACKGROUND

In a refrigeration apparatus, such as a refrigerator, a freezer, a combined fridge-freezer, etc., a common problem is an increase in humidity in the apparatus because of a build up of water droplets. Similarly, a common problem in such apparatus is an increase of particulates in the apparatus, such as for example dust, pollen and other airborne substances, including bacteria.

Some refrigeration apparatus have for example fan-based air circulation systems, but these typically do not lower the humidity or remove particulates from the refrigeration apparatus because typically there is no exhaust out of the refrigeration apparatus for the air. Some refrigeration apparatus have an air ionizer which creates charged ions which are intended to attract particulates. However, again, typically, these may not be effective as typically there is no exhaust out of the refrigeration apparatus for the ionized air and trapped particulates. Even if the refrigeration apparatus does have an exhaust for the moist or dirty air, typically that moist or dirty air is simply pushed into the room where the refrigeration apparatus is located, which may not be desirable.

Further, absorbent liners or pads are available for users to place on shelves or in a drawer of a refrigeration apparatus, in order to absorb moisture, etc. that is within the refrigeration apparatus. However, such liners are often inconvenient to use and may not be very effective.

### SUMMARY

According to a first aspect disclosed herein, there is provided a refrigeration apparatus, the refrigeration apparatus comprising:
a cool chamber for receiving items to be cooled in use by the refrigeration apparatus; and
a guide arrangement for guiding movement of a moisture-absorbing sheet into and out of the cool chamber;
the guide arrangement being constructed and arranged to guide a said moisture-absorbing sheet into position within the cool chamber as a said moisture-absorbing sheet is introduced into the refrigeration apparatus so that said moisture-absorbing sheet can absorb moisture in the cool chamber, and
the guide arrangement being constructed and arranged to guide a said moisture-absorbing sheet out of the cool chamber when a said moisture-absorbing sheet is being removed from the refrigeration apparatus.

This allows the user easily and conveniently to the moisture-absorbing sheet into position in the cool chamber and to withdraw the sheet from the cool chamber when the sheet needs to be emptied of water and cleaned or replaced.

In an example, the cool chamber has at least a top wall, a back wall and a bottom wall, the guide arrangement being constructed and arranged to guide a said moisture-absorbing sheet into position within the cool chamber such that said moisture-absorbing sheet is adjacent at least one of the top wall, back wall and bottom wall.

In an example, the guide arrangement comprises at least one roller arranged such that movement of a said moisture-absorbing sheet into and out of the cool chamber is guided by said moisture-absorbing sheet moving over the roller.

In an example, the refrigeration apparatus comprises a winch having a winch cable to which a said moisture-absorbing sheet can be attached, the winch being operable at least to wind in the winch cable to pull a said moisture-absorbing sheet into the cool chamber.

In an example, a free end of the winch cable has a connection device to which a said moisture-absorbing sheet can be connected to attach said moisture-absorbing sheet to the winch cable.

In an example, the refrigeration apparatus comprises a motor which is operable to drive operation of the winch.

There is also provided, in combination, a refrigeration apparatus as described above and a moisture-absorbing sheet which can be guided into position within the cool chamber and out of the cool chamber by the guide arrangement.

In an example, the moisture-absorbing sheet comprises one or more permanent magnets for removably attaching the moisture-absorbing sheet to a wall of the cool chamber of the refrigeration apparatus.

In an example, the moisture-absorbing sheet comprises a low friction surface having a relatively low coefficient of friction to facilitate sliding of the moisture-absorbing sheet over one or more walls of the cool chamber as the moisture-absorbing sheet is moved into and out of the cool chamber.

In an example, the moisture-absorbing sheet comprises a water-absorbing surface which is opposed to the low friction surface, and a water-storage layer which is located between the water-absorbing surface and the low friction surface.

According to a second aspect disclosed herein, there is provided a moisture-absorbing sheet for locating in a cool chamber of a refrigeration apparatus, the moisture-absorbing sheet comprising:
a water-absorbing layer for absorbing moisture from a cool chamber of a refrigeration apparatus in which the sheet is located in use; and
a water-storage layer located inwardly of the water-absorbing layer for storing water that is absorbed by the water-absorbing surface;
wherein the water-absorbing layer is formed of a plurality of water-trapping wads for trapping moisture in a said cool chamber and a plurality of water-transporting wads for transporting water from the water-trapping wads to the water-storage layer.

In an example, the water-trapping wads are generally conical and are arranged with the bases of the cones of the water-trapping wads facing away from the water-absorbing layer such that the bases of the cones are directed towards a said cool chamber of a refrigeration apparatus in use.

In an example, the water-transporting wads are generally conical and are arranged with the bases of the cones of the water-transporting wads facing towards the water-absorbing layer.

In an example, the moisture-absorbing sheet comprises one or more permanent magnets for removably attaching the moisture-absorbing sheet to a wall of the cool chamber of a said refrigeration apparatus.

In an example, the moisture-absorbing sheet comprises a connection device for connecting the sheet to a connection device of a winch cable of a said refrigeration apparatus so that the sheet can be winched into a said refrigeration apparatus.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a front elevation of an example of a refrigeration apparatus with an example of a moisture-absorbing sheet according to an embodiment of the present disclosure;

FIG. 2 shows schematically a guide arrangement of the refrigeration apparatus of FIG. 1 and the moisture-absorbing sheet;

FIGS. 3A to 3C show schematically lateral cross-section of the refrigeration apparatus of FIG. 1 showing different stages when the moisture-absorbing sheet is being introduced into the refrigeration apparatus; and

FIG. 4 shows schematically a sectioned perspective view of an example of a moisture-absorbing sheet according to an embodiment of the present disclosure.

### DETAILED DESCRIPTION

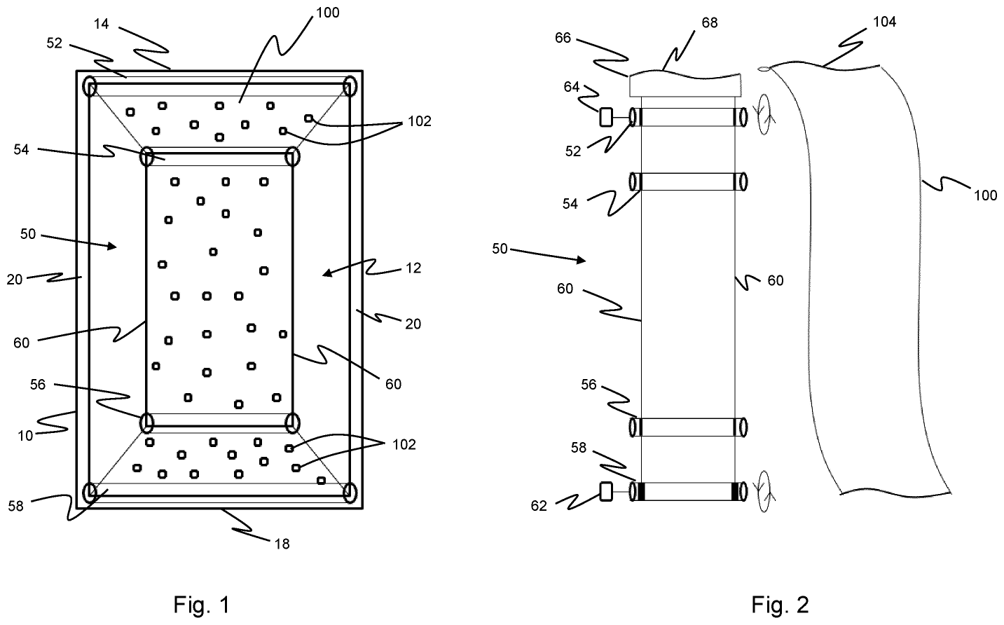

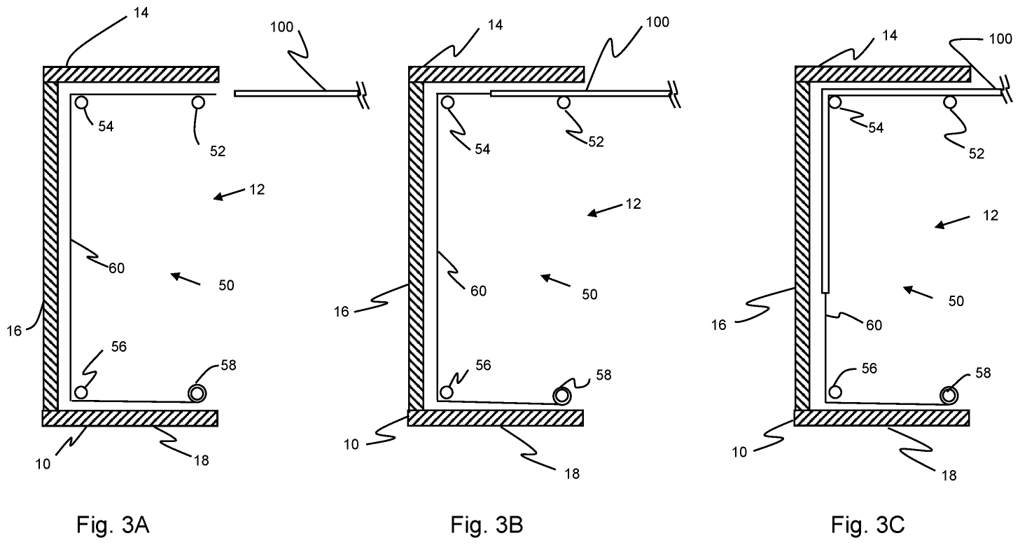

Referring particularly to FIGS. 1 to 3, there is shown an example of a refrigeration apparatus 10 with an example of a moisture-absorbing sheet 100 according to an embodiment of the present disclosure. The refrigeration apparatus 10 may be for example a refrigerator, a freezer, a combined fridge-freezer, etc. In FIG. 1, the sheet 100 is shown fully installed within the refrigeration apparatus 10. FIG. 2 shows schematically the moisture-absorbing sheet 100 and only a guide arrangement 50 of the refrigeration apparatus 10, with the rest of the refrigeration apparatus 10 not being shown for clarity. FIGS. 3A to 3C show different stages when the sheet 100 is being introduced into the refrigeration apparatus 10 or, correspondingly, when the sheet 100 is being withdrawn from or pushed out of the refrigeration apparatus 10.

The refrigeration apparatus 10 has a cool chamber 12 into which items to be cooled are placed in use. The cool chamber 12 has a top wall 14, a back wall 16 and a bottom wall 18. The cool chamber 12 in this example has opposed side walls 20, which can be seen in FIG. 1. It will be understood that the cool chamber 12 of this example has a fairly conventional rectangular cuboid shape, but that other shapes are possible. Nevertheless, as will become clear, operation of examples described herein is facilitated if any walls of the cool chamber 12 past and over which the sheet 100 moves in use are at least generally planar.

The refrigeration apparatus 10 also has the usual components (not shown) necessary to provide a vapour-compression refrigeration cycle for cooling the cool chamber 12, including for example an evaporator, a compressor, expansion valve, pipes for transporting a refrigerant, etc.

The guide arrangement 50 of the refrigeration apparatus 10 is used to guide the moisture-absorbing sheet 100 into the refrigeration apparatus 10 and out of the refrigeration apparatus 10. In particular, the guide arrangement 50 guides the sheet 100 into position within the cool chamber 12 as the sheet 100 is introduced into the refrigeration apparatus 10. Likewise, the guide arrangement 50 guides the sheet 100 out of the cool chamber 12 when the sheet 100 is being removed from the refrigeration apparatus 10.

In the example shown, the guide arrangement 50 is such that, when located in position in the cool chamber 12, the sheet 100 is adjacent to at least one of the top wall 14, back wall 16 and bottom wall 18 of the cool chamber 12. As will become clear, whether the sheet 100 is adjacent only to one of the top wall 14, the back wall 16 and the bottom wall 18, or is adjacent to the top wall 14 and the back wall 16, or is adjacent to the back wall 16 and the bottom wall 18, or is adjacent to all three walls 14, 16, 18, depends on how long the sheet 100 is, how long the walls 14, 16, 18 are, and how far into the cool chamber 12 the sheet 100 is inserted. To obtain a maximum area of the sheet 100 to absorb moisture, etc., the sheet 100 should cover all three walls 14, 16, 18 as shown schematically in FIG. 1. Nevertheless, in other examples, it may be convenient for the sheet 100 only to cover say the top wall 14 and the back wall 16 as users may want to locate items to be cooled on the bottom wall 18 without the sheet 100 being present on top of the bottom wall 18.

In any event, an advantage of locating the sheet 100 adjacent one or more walls 14, 16, 18 of the cool chamber 12 is that the moisture-absorbing sheet 100 is kept away from the main interior portion of the cool chamber 12. This means that the sheet 100 does not take up space that is intended to be for items to be cooled in the cool chamber 12. Also, if for example the sheet is not adjacent the bottom wall 18 then, compared to for example known absorbent liners or pads which typically are located on shelves or in drawers of a refrigeration apparatus, this means that the items to be cooled in the cool chamber 12 do not have to sit on the sheet 100. This avoids the items to be cooled sitting on liners that over time can become wet owing to the amount of moisture they have absorbed, which can spoil the items to be cooled in known arrangements.

A number of different arrangements for the guide arrangement 50 are possible. For example, the guide arrangement 50 may be formed of or include one or more sliders over which the sheet 100 can slide as the sheet 100 is introduced into and removed from the cool chamber 12. The sliders may for example be in the form of a number of rods or rails or the like which extend laterally across the interior of the cool chamber 12 and which are static or fixed.

In the example shown, the guide arrangement 50 is provided by a number of rollers 52, 54, 56, 58 which extend laterally across the interior of the cool chamber 12 and which are mounted so as to be able to rotate about their respective longitudinal axes. The rollers 52, 54, 56, 58 help make movement of the sheet 100 into and out of the cool chamber 12 easier. The rollers 52, 54, 56, 58 can also assist in locating the sheet 100 correctly in the cool chamber 12 and can help keep the sheet 100 flat.

In particular, in this example, there is a first roller 52 which is mounted to extend across the top front of the cool chamber 12; there is a second roller 54 which is mounted to extend across the top rear of the cool chamber 12; there is a third roller 56 which is mounted to extend across the bottom rear of the cool chamber 12; and there is a fourth roller 58 which is mounted to extend across the bottom front of the cool chamber 12. In each case, each roller 52, 54, 56, 58 is mounted close to but spaced from the respective top, back and bottom wall or walls 14, 16, 18 of the cool chamber 12. As can be seen most clearly in FIGS. 3A to 3C, this allows space for the sheet 100 to be introduced into the cool chamber 12 whilst still being adjacent or close to the respective wall 14, 16, 18. It will be appreciated that, in other examples, there may be fewer or more rollers located to extend laterally across the interior of the cool chamber 12, possibly at different locations from the examples shown in the drawings.

In use, a user can feed the sheet 100 into the cool chamber 12 of the refrigeration apparatus 10 by for example inserting a free end of the sheet 100 into the space between the top wall 14 and the top front roller 52 or, perhaps less conveniently, into the space between the bottom wall 18 and the bottom front roller 58. The user can then manipulate the sheet 100 to feed it around the other rollers 54, 56, 58/52 as the case may be, until the sheet 100 is located at a desired position within the cool chamber 12. The user can pull the sheet 100 out of the cool chamber 12 in a similar manner.

However, to facilitate the insertion of the sheet 100 into the cool chamber 12, in the example shown the bottom front roller 58 acts as a winch. At least one guide cable or rope 60 is fixed at one end to the bottom front roller 58. In the example shown, two guide cables or ropes 60 are fixed at one end to the bottom front roller 58. In the example shown, the two guide cables 60 are fixed at opposed ends of the bottom front roller 58.

Referring particularly now to FIGS. 3A to 3C, when it is desired to insert a sheet 100 into the cool chamber 12, the sheet 100 is connected to the guide cables 60, it being understood that at this point, the free ends of the guide cables 60 are projecting just forwards (towards the open front of the cool chamber 12) of the top front roller 52. The bottom front roller 58 is then caused to rotate to pull the sheet 100 into the cool chamber 12. Referring to FIG. 3B, the sheet 100 moves over the top front roller 52 in the space between the top front roller 52 and the interior surface of the top wall 14 of the cool chamber 12. Referring to FIG. 3C, continued rotation of the bottom front roller 58 pulls the sheet 100 over the top rear roller 54 down towards the bottom rear roller 56. Continued rotation of the bottom front roller 58 pulls the sheet 100 under the bottom rear roller 56 towards the bottom front roller 58. See FIG. 1. Again, it is noted that it may not always be necessary or desirable to pull the sheet 100 so far in that it extends over the bottom wall 18 of the cool chamber 12, and it may for example be sufficient or preferred only for the sheet 100 to extend over the top wall 14 and the rear wall 16 or possibly only the top wall 14 or the rear wall 16.

Accordingly, in this example, the guide arrangement 50 can be used to pull the sheet 100 into the cool chamber 12 and also locates the sheet 100 to be adjacent or close to the respective walls 14, 16, 18 of the cool chamber 12.

The bottom front roller 58 when acting as a winch as described may be manually turned by the user as desired. Alternatively, as shown in the example shown in the figures, the bottom front roller 58 may be driven to rotate by an electric motor 62. The electric motor 62 may be caused to operate by for example the user pressing a start button or the like once the user has connected the sheet 100 to the guide cables 60. As an alternative, some sensor arrangement may be provided to operate the motor 62 automatically when it detects that the sheet 100 has been connected to the guide cables 60. As a further option, one or more of the other rollers 52, 54, 56 may also be driven to rotate by respective electric motors when desired. As a particular example, an electric motor 64 is provided to cause rotation of the top front roller 52, with the rotation of this top electric motor 64 being coordinated with the rotation of the bottom electric motor 62 which is provided for the bottom front roller 58.

In order to assist in keeping the sheet 100 close to the one or more walls 14, 16, 18 of the cool chamber 12, and in the case that the walls 14, 16, 18 are formed of or contain a magnetic material, the sheet 100 of this example has a plurality of permanent magnets 102. The magnets 102 are arranged in the body of the sheet 100 so as preferably not to protrude from the surface of the sheet 100, as otherwise the magnets 102 may obstruct movement of the sheet 100 across the rollers 52, 54, 56, 58. The magnets 102 removably attach the sheet 100 to the relevant one or more walls 14, 16, 18 of the cool chamber 12. It will be understood that the magnets 102 as a whole should not be so strongly magnetic as to prevent movement of the sheet 100 past the walls 14, 16, 18 of the cool chamber 12 as the sheet 100 is moved into and out of the cool chamber 12. The magnets 102 may be in the form of small button type magnets, strips, etc.

In order to connect the sheet 100 to the guide cables 60, a number of options are available. The sheet 100 can for example have a number of resilient sockets at one end and the guide cables 60 can be pushed into the sockets to retain the sheet 100 connected to the sockets. As another example, one or more interlocking parts may be provided on the sheet 100 and on or associated with the guide cables 60 to releasably lock the sheet 100 to the guide cables 60. Referring particularly to FIG. 2, there may be for example a strip 66 of material which is connected to the guide cables 60 to extend between the guide cables 60. This strip 66 may have for example a number of parts that mate with corresponding parts provided at one end of the sheet 100 to connect the sheet 100 to the guide cables 60. As one example, the strip 66 and the sheet 100 may be provided with respective parts of press studs or press fasteners or the like. In another example indicated schematically in FIG. 2, which is likely to be most convenient for the user, the strip 66 and the sheet 100 may be provided with respective parts of a zip fastener 68, 104 so that the user can zip the sheet 100 to the strip 66 and unzip the sheet 100 from the strip 66 when needed.

Accordingly, in short in the example shown, the user can insert a fresh, dry moisture-absorbing sheet 100 into the cool chamber 12 of the refrigeration apparatus using the guide arrangement 50, using the bottom front roller 58 as a winch to pull the sheet 100 into the refrigeration apparatus 10 and the cool chamber 12. The guide arrangement 50 guides the movement of the sheet 100 so that the sheet 100 is close to the walls 14, 16, 18 of the cool chamber 12. When the sheet 100 is fully inserted, movement of the sheet 100 is stopped. This allows the permanent magnets 102 to pull the sheet into contact with the walls 14, 16, 18 of the cool chamber 12, which keeps the sheet 100 out of the main part of the cool chamber 100 so that the sheet 100 does not obstruct or prevent the user putting items in and removing items from the cool chamber 12. Over time, the sheet 100 will have absorbed water moisture, and possibly also particulates. The user can then reverse the operation described above to withdraw the sheet 100 from the cool chamber 12. The user can then dispose of the sheet 100 and replace it with a new one or, more preferably, wash and dry the sheet 100 and insert it again into the cool chamber 12.

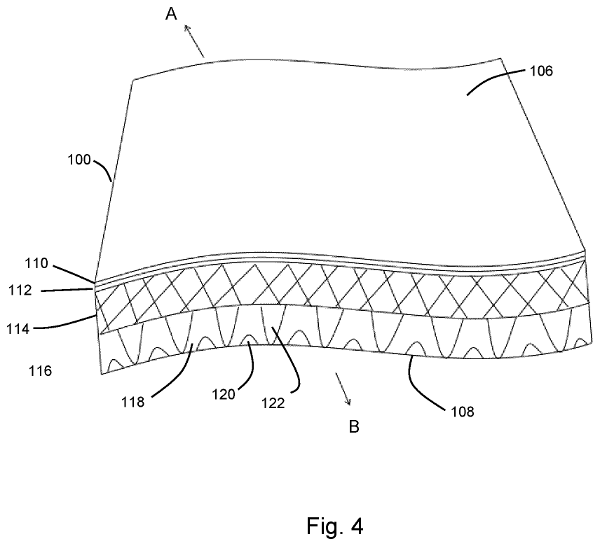

Referring now to FIG. 4, this shows schematically a sectioned perspective view of part of an example of a moisture-absorbing sheet 100 according to an embodiment of the present disclosure. The sheet 100 may be used with the refrigeration apparatus 10 described above. The sheet 100 has a number of layers which variously provide the moisture-absorbing properties of the sheet 100 and enable or facilitate insertion of the sheet 100 into and removal from the refrigeration apparatus 10, as will now be described. In general, the sheet 100 should have some flexibility so that it can bend round the rollers 52, 54, 56, 58 as the sheet 100 is inserted into and removed from the refrigeration apparatus 10.

In FIG. 4, the arrow A is pointing towards the direction of the walls 14, 16, 18 of the refrigeration apparatus 10 such that the upper surface 106 of the sheet 100 shown in FIG. 4 faces the walls 14, 16, 18 of the refrigeration apparatus 10 when the sheet 100 has been inserted into the refrigeration apparatus 10. Correspondingly, the arrow B is pointing towards the interior of the cool chamber 12 when the sheet 100 has been inserted into the refrigeration apparatus 10 such that the lower surface 108 of the sheet 100 shown in FIG. 4 faces the interior of the cool chamber 12.

Moving through the layers of the sheet 100 in turn from the surface 106 that faces the walls 14, 16, 18 of the refrigeration apparatus 10 to the surface 108 that faces the interior of the cool chamber 12, a first layer 110 of the sheet 100 is formed of a material that has one or more of a number of properties. A first desirable property is that the first layer 110 has a relatively low coefficient of friction (at least compared to say the other surface 108 of the sheet 100). This is so that the sheet 100 can more easily slide over the walls 14, 16, 18 of the refrigeration apparatus 10 as the sheet 100 is inserted into and removed from the refrigeration apparatus 10. A second desirable property is that the first layer 110 is waterproof so that water moisture absorbed by the sheet 100 from the cool chamber 12 does not pass through the sheet 100. The first layer 110 may be formed of for example a polymer, including for example polyethylene, polyvinyl chloride, nylon, etc.

FIG. 4 shows a second layer 112 inwardly of the first layer 110. This second layer 112 contains the permanent magnets 102 discussed above which help secure the sheet 100 to the walls 14, 16, 18 of the refrigeration apparatus 10. The second layer 112 may be formed of for example a polymer, including for example polyethylene, polyvinyl chloride, nylon, etc. Whilst shown as separate layers, in another example, the first layer 110 may contain the permanent magnets 102 and there is no separate layer like the second layer 112 provided only for containing the permanent magnets 102.

The sheet 100 then has a third layer 114. The primary function of the third layer 114 is to store water that has been absorbed from the interior of the cool chamber 12. The third layer 114 is therefore formed of a material that can store water. Suitable examples include natural or synthetic sponges, with a synthetic sponge typically being formed of for example polyester, polyurethane, vegetal cellulose, etc. The sponge of the third layer 114 may be in compressed form.

The sheet 100 then has a fourth and final layer 116. The primary function of the fourth layer 116 is to absorb or trap moisture that is within the interior of the cool chamber 12 and drive or transport that trapped moisture to the third, water-storage layer 114. Various different arrangements for the fourth layer 116 are possible. In the example shown in FIG. 4, the fourth layer 116 has three main components. In particular, the fourth layer 116 has a main substrate 118, a plurality of water-trapping buds or wads 120 and a plurality of water-transporting buds or wads 122.

The water-trapping wads 120 are located at or towards the surface 108 that faces the interior of the cool chamber 12 in use. In the example shown, the water-trapping wads or buds 120 are conical or generally conical, with the bases of the cones of the wads 120 facing outwardly of the surface 108 that faces the interior of the cool chamber 12 in use and the tips of the cones facing inwardly of the sheet 100. This means that a large part, and in some examples, all of the surface 108 is effectively provided by the water-trapping wads 120, which maximises the ability of the sheet 100 to absorb moisture from the cool chamber 12.

The water-transporting wads 122 are located at or towards the opposite side of the fourth layer 116, i.e. inwardly of the sheet 100. In the example shown, the water-transporting wads 122 are conical or generally conical, with the bases of the cones of the wads 122 facing inwardly of the sheet 100 and the tips of the cones facing outwardly of the sheet 100 towards the surface 108 that faces the interior of the cool chamber 12 in use.

In use when the sheet 100 is installed in a refrigeration apparatus 10, the water-trapping wads 120 absorb water from the interior of the cool chamber 12. The ability of the water-trapping wads 120 to absorb water is increased when the water-trapping wads 120 are conical and have their bases towards the interior of the cool chamber 12. Water that is trapped at the bases of the water-trapping wads 120 passes through the water-trapping wads 120 to their tips. That water is then collected by the water-transporting wads 122. As mentioned, the water-trapping wads 120 and the water-transporting wads 122 may be provided in a main substrate 118 and therefore the water trapped by the water-trapping wads 120 may pass to the water-transporting wads 122 via the substrate 118. In other examples, there may be no substrate as such, and the fourth layer 116 is instead formed only of the water-trapping wads 120 and the water-transporting wads 122 such that water passes directly between the buds 120, 122. In any event, water that has passed to the tips of the water-transporting wads 122 is transported to the bases of the water-transporting wads 122 and, from there, the water passes to the third layer 114 to be stored.

The material of the water-trapping wads 120 may be selected to increase the ability of the wads 120 to absorb water from the interior of the cool chamber 12. For example, the water-trapping wads 120 may be formed of cotton or some cotton-based absorbent material, which may be for example wrapped or compressed or woven to provide a high density; common flax or linseed or linen formed from common flax or linseed; polypropylene or some polypropylene-based absorbent material, including for example cellulose fibre reinforced polypropylene; or mixtures thereof. The material of the water-transporting wads 122 may be selected to increase the ability of the wads 122 to transport the water to the third layer 114 to be stored. A material that provides a low surface friction is an example of a suitable material. For example, the water-transporting wads 122 may be formed of silk or some silk-based material; polythene or some polythene-based material; wool or some wool-based material; viscose some viscose-based material; nylon some nylon-based material; or mixtures thereof.

As noted, such a sheet 100 has some flexibility so that it can bend round the rollers 52, 54, 56, 58 as the sheet 100 is inserted into and removed from the example of the refrigeration apparatus 10 as described above. Once the sheet 100 has absorbed water moisture, and possibly also particulates, and becomes full, the user can remove the sheet 100 and preferably wash and dry the sheet 100 and insert it again into the cool chamber 12 so as to re-use the sheet 100.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A refrigeration apparatus, the refrigeration apparatus comprising:
a cool chamber for receiving items to be cooled in use by the refrigeration apparatus; and
a guide arrangement for guiding movement of a moisture-absorbing sheet into and out of the cool chamber;
the guide arrangement being constructed and arranged to guide the moisture-absorbing sheet into position within the cool chamber as the moisture-absorbing sheet is introduced into the refrigeration apparatus so that the moisture-absorbing sheet can absorb moisture in the cool chamber, and
the guide arrangement being constructed and arranged to guide the moisture-absorbing sheet out of the cool chamber when the moisture-absorbing sheet is being removed from the refrigeration apparatus.

2. A refrigeration apparatus according to claim 1, wherein the cool chamber has at least a top wall, a back wall and a bottom wall, the guide arrangement being constructed and arranged to guide the moisture-absorbing sheet into position within the cool chamber such that the moisture-absorbing sheet is adjacent at least one of the top wall, back wall and bottom wall.

3. A refrigeration apparatus according to claim 1, wherein the guide arrangement comprises at least one roller arranged such that movement of the moisture-absorbing sheet into and out of the cool chamber is guided by the moisture-absorbing sheet moving over the roller.

4. A refrigeration apparatus according to claim 1, comprising a winch having a winch cable to which the moisture-absorbing sheet can be attached, the winch being operable at least to wind in the winch cable to pull the moisture-absorbing sheet into the cool chamber.

5. A refrigeration apparatus according to claim 4, wherein a free end of the winch cable has a connection device to which the moisture-absorbing sheet can be connected to attach the moisture-absorbing sheet to the winch cable.

6. A refrigeration apparatus according to claim 4, comprising a motor which is operable to drive operation of the winch.

7. A refrigeration apparatus, refrigeration apparatus comprising:
a cool chamber for receiving items to be cooled in use by the refrigeration apparatus;
a moisture-absorbing sheet which can be guided into position within the cool chamber and out of the cool chamber;
a guide arrangement for guiding movement of be moisture-absorbing sheet into and out of the cool chamber;
the guide arrangement being constructed and arranged to guide the moisture-absorbing sheet into position within the cool chamber as the moisture-absorbing sheet is introduced into the refrigeration apparatus so that the moisture-absorbing sheet can absorb moisture in the cool chamber, and
the guide arrangement being constructed and arranged to guide the moisture-absorbing sheet out of the cool chamber when the moisture-absorbing sheet is being removed from the refrigeration apparatus.

8. A refrigeration apparatus according to claim 7, wherein the moisture-absorbing sheet comprises one or more permanent magnets for removably attaching the moisture-absorbing sheet to a wall of the cool chamber of the refrigeration apparatus.

9. A refrigeration apparatus according to claim 7, wherein the moisture-absorbing sheet comprises a low friction surface having a relatively low coefficient of friction to facilitate sliding of the moisture-absorbing sheet over one or more walls of the cool chamber as the moisture-absorbing sheet is moved into and out of the cool chamber.

10. A refrigeration apparatus according to claim 9, wherein the moisture-absorbing sheet comprises a water-absorbing surface which is opposed to the low friction surface, and a water-storage layer which is located between the water-absorbing surface and the low friction surface.

11. A moisture-absorbing sheet for locating in a cool chamber of a refrigeration apparatus, the moisture-absorbing sheet comprising:
a water-absorbing layer for absorbing moisture from a cool chamber of a refrigeration apparatus in which the sheet is located in use; and
a water-storage layer located inwardly of the water-absorbing layer for storing water that is absorbed by the water-absorbing surface;
wherein the water-absorbing layer is formed of a plurality of water-trapping wads for trapping moisture in the cool chamber and a plurality of water-transporting wads for transporting water from the plurality of water-trapping wads to the water-storage layer.

12. A moisture-absorbing sheet according to claim 11, wherein the plurality of water-trapping wads are generally conical and are arranged with the bases of the cones of the plurality of water-trapping wads facing away from the water-absorbing layer such that the bases of the cones are directed towards the cool chamber of a refrigeration apparatus in use.

13. A moisture-absorbing sheet according to claim 11, wherein the plurality of water-transporting wads are generally conical and are arranged with the bases of the cones of the plurality of water-transporting wads facing towards the water-absorbing layer.

14. A moisture-absorbing sheet according to claim 11, comprising one or more permanent magnets for removably attaching the moisture-absorbing sheet to a wall of the cool chamber of the refrigeration apparatus.

15. A moisture-absorbing sheet according to claim 11, comprising a connection device for connecting the sheet to a connection device of a winch cable of the refrigeration apparatus so that the sheet can be winched into the refrigeration apparatus.

16. A moisture-absorbing sheet according to claim 11, wherein the moisture-absorbing sheet comprises a low friction surface having a relatively low coefficient of friction to facilitate sliding of the moisture-absorbing sheet over one or more walls of the cool chamber as the moisture-absorbing sheet is moved into and out of the cool chamber.

17. A moisture-absorbing sheet according to claim 16, wherein the low friction surface is opposed to the water-absorbing layer and the water-storage layer is located between the water-absorbing layer and the low friction surface.
